(19) United States
(12) Patent Application Publication
(10) Pub. No.: US 2021/0062013 A1
(43) Pub. Date: Mar. 4, 2021

(54) METHOD OF PRODUCING SILVER NANOPARTICLES, AND SILVER PASTE CONTAINING SILVER NANOPARTICLES

(71) Applicant: Noritake Co., Limited, Nagoya-shi, Aichi (JP)

(72) Inventors: Yukiko Kikugawa, Nagoya-shi, Aichi (JP); Sahoko Sumida, Nagoya-shi, Aichi (JP)

(21) Appl. No.: 16/960,208

(22) PCT Filed: Dec. 26, 2018
(86) PCT No.: PCT/JP2018/047866

§ 371 Date: Jul. 6, 2020

(30) Foreign Application Priority Data
Jan. 9, 2018 (JP) 2018-001514

(51) Int. Cl. C09D 5/24; C09D 7/62; C09D 7/40; H01B 1/02; B22F 9/30; B22F 1/00

(52) U.S. Cl. CPC C09D 5/24; C09D 7/62; C09D 7/67; C09D 7/68; B22F 2304/056; B22F 9/30; B22F 1/0018; B22F 2301/255; B22F 2304/054; H01B 1/02

(57) ABSTRACT

According to the present invention, provided is a method of producing silver nanoparticles including a mixing step of mixing a thermally decomposable silver compound, an amine compound having 5 or less carbon atoms, and a solvent including an organic solvent having a Log P_{OW} of 2.0 to 4.0 at a temperature at which the silver compound and the amine compound chemically react; a first heating step of heating a mixed liquid obtained in the mixing step to a first temperature lower than a decomposition temperature of the silver compound; and a second heating step of heating the mixed liquid containing nuclei of the silver nanoparticles to a second temperature equal to or higher than a decomposition temperature of the silver compound.

### TECHNICAL FIELD

The present invention relates to a method of producing silver nanoparticles and a silver paste containing silver nanoparticles.

Priority is claimed on Japanese Patent Application No. 2018-001514, filed Jan. 9, 2018, the content of which is incorporated herein by reference.

### BACKGROUND ART

Silver (Ag) has excellent electrical conductivity, thermal conductivity, light reflectance with respect to visible light, and the like. In addition, silver (Ag) has a catalytic effect and a bactericidal effect. With such characteristics, silver (Ag) has been conventionally widely used in electronic wirings of electronic components, and the like, conductive adhesives, printed electronics, reflective materials, antibacterial agents, catalysts, and the like. Patent Literature 1 to 3 discloses methods of producing silver nanoparticles that can be used in such applications.

For example, Patent Literature 1 discloses a method in which silver oxalate is reacted with oleylamine to generate a complex compound containing silver, oleylamine, and oxalate ions, the generated complex compound is then thermally decomposed, and silver ultrafine particles with an average particle size of about 5 to 20 nm are produced.

### CITATION LIST

### Patent Literature

Patent Literature 1: Japanese Patent Application Publication No. 2008-214695
Patent Literature 2: Japanese Patent Application Publication No. 2015-4123
Patent Literature 3: Japanese Patent Application Publication No. 2013-142173

### SUMMARY OF INVENTION

However, according to studies by the inventors, in the above production method, when production of silver nanoparticles having a larger average particle size, for example, silver nanoparticles with an average particle size of about 50 nanometers to several hundreds of nanometers, is attempted, there are problems that it is difficult to control the particle size and the variation in particle size between production lots increases. Such variation in particle size directly leads to qualitative variation in the final product. Therefore, there is demand for a production method in which variation in particle size between production lots is reduced, and silver nanoparticles having a stable average particle size can be obtained with favorable reproducibility.

In addition, in Patent Literature 1, when silver is covered with a long-chain amine (oleylamine) represented by a molecular formula C₁₈H₃₇N, silver ultrafine particles are stably maintained. Therefore, for silver ultrafine particles obtained by the production method disclosed in Patent Literature 1, in order to realize excellent conductivity suitable for practical applications, it is necessary to increase a firing temperature and lengthen a firing time. However, in consideration of energy, costs, and production efficiency, it is desired to lower the firing temperature and shorten the firing time.

The present invention has been made in view of the above circumstances, and an object of the present invention is to provide a production method in which variation between production lots is reduced and silver nanoparticles of which the particle size is controlled can be obtained with favorable reproducibility. Another related object is to provide a silver paste containing silver nanoparticles that can be sintered at a low temperature and in a short time.

According to the present invention, a method of producing silver nanoparticles is provided. This production method includes a mixing step of mixing a thermally decomposable silver compound, an amine compound having 5 or less carbon atoms, and a solvent including an organic solvent having an octanol/water partition coefficient Log P_{OW} of 2.0 to 4.0 at a temperature at which the silver compound and the amine compound do not chemically react; a first heating step of heating a mixed liquid obtained in the mixing step to a first temperature lower than a decomposition temperature of the silver compound to generate nuclei of the silver nanoparticles in the mixed liquid; and a second heating step of heating the mixed liquid containing nuclei of the silver nanoparticles to a second temperature equal to or higher than a decomposition temperature of the silver compound to generate the silver nanoparticles in the mixed liquid.

According to the above production method, it is possible to stably control generation and growth of nucleus of silver nanoparticles. With this feature, variation between production lots is reduced, and silver nanoparticles having a desired particle size can be obtained with favorable reproducibility. In addition, it is possible to stably obtain silver nanoparticles that can be sintered at a low temperature and in a short time.

In a preferable aspect disclosed here, in the first heating step, the first temperature is set to a temperature 15° C. to 30° C. lower than a decomposition temperature of the silver compound. With this feature, nuclei can be more stably generated in the mixed liquid. In addition, it is possible to improve the production efficiency.

In a preferable aspect disclosed here, in the first heating step, the heating time is set to 20 minutes or shorter. In another preferable aspect disclosed here, in the second heating step, the heating time is set to 20 minutes or shorter. With this feature, it is possible to minimize melting and fusion of nuclei in the mixed liquid and obtain silver nanoparticles with higher homogeneity. In addition, it is possible to improve the production efficiency.

In a preferable aspect disclosed here, in the mixing step, a ratio of the number of moles of the amine compound to the number of moles of the silver compound is 1 or less. With this feature, it is possible to obtain silver nanoparticles having both low temperature sinterability and long-term storage properties to a higher degree.

In addition, according to another aspect of the present invention, a silver paste including silver nanoparticles and an organic solvent is provided. The silver nanoparticles include silver serving as a core and an amine compound having 5 or less carbon atoms attached to the surface thereof. A ratio (M_{NH2}/M_{Ag}) of the number of moles of the amine compound to the number of moles of silver serving as the core is 1 or less. Even if the particles are left under an environment of 25° C. for 10 months, aggregates with a size of 1 μm or more are not observed in measurement using a grind gauge.

That is, in the silver paste disclosed here, the number of carbon atoms of the amine compound is small at 5 or less and the molar amount of the amine compound with respect to silver is minimized. According to the silver paste, it is possible to lower the sintering temperature and shorten the time thereof, it is possible to reduce energy and costs, and it is possible to improve the production efficiency. In addition, the silver nanoparticles of the silver paste disclosed here have excellent storage stability even though the number of carbon atoms of the amine compound attached to the surface is small at 5 or less and the molar amount of the amine compound with respect to silver serving as a core is minimized. Therefore, it is possible to stably form a homogenous fired film (conductive layer) after long-term storage.

In a preferable aspect disclosed here, the silver nanoparticles have an average particle size of 50 to 200 nm in a number-based particle size distribution based on an observation image under a field emission scanning electron microscope. With this feature, it is possible to obtain low temperature sinterability and long-term storage properties to a higher degree.

In a preferable aspect disclosed here, in the silver nanoparticles, in a number-based particle size distribution, a width W:W=(D₉₀ particle size−D₁₀ particle size)/D₅₀ particle size of a particle size distribution calculated from a D₁₀ particle size corresponding to a cumulative 10% from the side of a smaller particle size, a D₅₀ particle size corresponding to a cumulative 50% from the side of a smaller particle size, and a D₉₀ particle size corresponding to a cumulative 90% from the side of a smaller particle size is 0.5 or more and 1 or less. With this feature, it is possible to appropriately form a fired film (conductive layer) in which at least one of smoothness, homogeneity, a density, and a filling property is improved.

### BRIEF DESCRIPTION OF DRAWINGS

FIG. 1 is a flowchart for explaining a production method according to an embodiment.

FIG. 2 is a flowchart for explaining a production method according to Comparative Example 1.

FIG. 3 is an example of an FE-SEM observation image of silver nanoparticles of Example 1.

FIG. 4 is an example of an FE-SEM observation image of silver nanoparticles of Comparative Example 1.

FIG. 5 is a graph showing variation between lots of silver nanoparticles of Example 1.

FIG. 6 is a graph showing variation between lots of silver nanoparticles of Comparative Example 1.

FIG. 7 is an FE-SEM observation image of silver nanoparticles of Example 2.

FIG. 8 is an FE-SEM observation image of silver nanoparticles of Example 3.

FIG. 9 is an FE-SEM observation image of silver nanoparticles of Example 4.

FIG. 10 is an FE-SEM observation image of silver nanoparticles of Comparative Example 3.

FIG. 11 is a graph showing the relationship between firing conditions and a volume resistivity of a silver paste of Example 1.

FIG. 12 shows schematic explanatory diagrams for explaining a method of evaluating aggregates using a grind gauge, FIG. 12(a) shows a cross-sectional view, and FIG. 12(b) shows a plan view.

FIG. 13 is a graph showing the relationship between a firing temperature and a volume resistivity of a silver paste of Example 3.

### DESCRIPTION OF EMBODIMENTS

Preferable embodiments of the present invention will be described below. Here, components other than those particularly mentioned in this specification that are necessary for implementing the present invention can be recognized by those skilled in the art as design matters based on the related art in the field. The present invention can be implemented based on content disclosed in this specification and common general technical knowledge in the field.

Here, in this specification, “silver nanoparticles” refer to those having an arithmetic average value of 1 nm to several hundreds of nm (in other words, an average particle size based on number) of Feret diameters measured from an observation image of a field emission-scanning electron microscope (FE-SEM). In a narrower sense, the particles have a size of about 50 nm or more, for example, 50 to 300 nm, distinctively from the silver ultrafine particles described in Patent Literature 1. In addition, in this specification, the notation indicating a range of “A to B” means A or more and B or less.

<<Method of Producing Silver Nanoparticles>>

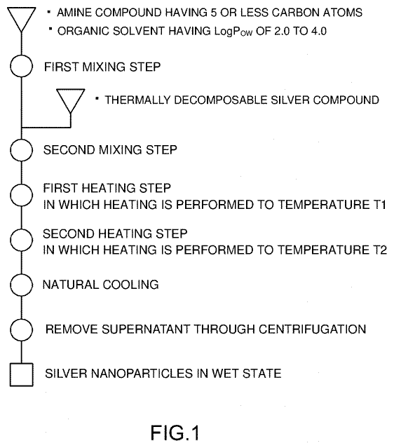

FIG. 1 is a flowchart for explaining a production method according to an embodiment. The production method shown in FIG. 1 is a liquid phase method. The production method shown in FIG. 1 includes the following steps: (Step 1) mixing step; (Step 2) first heating step; and (Step 3) second heating step. The production method shown in FIG. 1 is a so-called thermal decomposition method without using a reducing agent. Specifically, this is a method of obtaining silver nanoparticles by heating a mixed liquid obtained in the mixing step in two steps. Hereinafter, the steps will be described with reference to FIG. 1.

(Step 1) Mixing Step

In this step, a silver compound and an amine compound are mixed in a solvent to prepare a mixed liquid. The mixed liquid is prepared at a temperature at which a silver compound and an amine compound do not chemically react. The mixed liquid may be prepared at about 40° C. or lower, typically at room temperature (for example, 25±10° C., and preferably 25±5° C.). The mixed liquid is prepared, typically, under an air atmosphere. However, this step may be performed under an inert atmosphere such as nitrogen, argon, and helium.

The order of mixing a silver compound, an amine compound, and a solvent is not particularly limited. For example, all components may be added and mixed at the same time or one of a silver compound and an amine compound may be dissolved or dispersed in a solvent in advance and the other may be then added and mixed. In the aspect shown in FIG. 1, a mixing step includes a first mixing step of adding an amine compound to a solvent to prepare a preliminary mixed liquid and a second mixing step of adding a silver compound to the preliminary mixed liquid prepared in the first mixing step to prepare a mixed liquid. Before the silver compound is added, an amine compound is added to a solvent in advance and thus more homogeneous silver nanoparticles can be obtained.

In the first mixing step, first, a solvent and an amine compound are prepared. Regarding the solvent, an organic solvent having at least an octanol/water partition coefficient Log P_{OW} of 2.0 to 4.0 is used. The octanol/water partition coefficient is an index indicating hydrophilicity/hydrophobicity and a smaller value indicates stronger hydrophilicity, and a larger value indicates stronger hydrophobicity. When an organic solvent having a Log P_{OW} of a predetermined value or less is used, nuclei can be stably generated in the first heating step to be described below and the nuclei can appropriately grow in the second heating step. In addition, when an organic solvent having a Log P_{OW} of a predetermined value or more is used, the hydrophobicity of the solvent can be increased to some extent. Therefore, in the second mixing step to be described below, it is possible to minimize the occurrence of coordination competition between the solvent and the amine compound on the surface of the silver compound, and it is possible to appropriately coordinate the amine compound on the surface of the silver compound. In addition, in the first heating step to be described below, silver clusters and silver nano colloids serving as nuclei of silver nanoparticles can be slowly generated. In consideration of this, an organic solvent having a Log P_{OW} of 3.0 or more, for example, 3.4 or more, particularly 3.5 or more, and having stronger hydrophobicity is preferable. Here, in this specification, “octanol/water partition coefficient” is a value measured according to a “flask shaking method” defined in JIS Z 7260-107: 2000.

Regarding an organic solvent having a Log P_{OW} of 2.0 to 4.0, conventionally known organic solvents can be used without particular limitation. Specific examples (and their Log P_{OW} values) of such an organic solvent include, for example, alcohol solvents such as hexanol (2.03), 1-octanol (2.81), texanol (3.47), 1-decanol (3.79), and isodecanol (3.94); (meth)acrylic solvents such as butyl acrylate (2.38), butyl methacrylate (2.26 to 3.01), N-hexyl acrylate (3.3), and 2-ethylhexyl acrylate (3.67); and hydrocarbon solvents such as toluene (2.73), styrene (2.95), and α-methylstyrene (3.48). Among these, an alcohol solvent such as texanol and isodecanol is preferable. Here, in this specification, the term “(meth)acryl” includes acrylic and methacryl.

The solvent may be composed of only an organic solvent having a Log P_{OW} of 2.0 to 4.0 as described above, and additionally, various solvents that are known to be usable for this type of application may be contained as long as the effects of the technology disclosed here are not significantly reduced. In addition, an organic solvent having a Log P_{OW} of 2.0 to 4.0 may contain inevitable impurities as long as the effects of the technology disclosed here are not significantly reduced. Examples of components that may be included in a solvent intentionally or inevitably include organic solvents such as an alcohol solvent, an amide solvent, a ketone solvent, an ester solvent, an amine solvent, an ether solvent, a nitrile solvent, and a hydrocarbon solvent other than those described above and water.

In order to exhibit the effects of the technology disclosed here more favorably, a proportion of the organic solvent having a Log P_{OW} of 2.0 to 4.0 is preferably about 50 mass % or more, typically 80 mass % or more, and preferably 90 mass % or more, for example, 95 mass % or more, with respect to the entire solvent. In addition, a proportion of the solvent that may be included intentionally or inevitably may be about 20 mass % or less, typically 10 mass % or less, preferably 5 mass % or less, and more preferably 2 mass % or less, for example, 1 mass % or less, with respect to the entire solvent. In addition, the Log P_{OW} of the entire solvent is preferably about 4.0 or less, for example, 2.0 to 4.0. In addition, it is preferable that the solvent do not include an organic solvent having a Log P_{OW} of less than 1.0 and having strong hydrophilicity and/or an organic solvent having a Log P_{OW} of more than 5.0 and having strong hydrophobicity.

Here, Patent Literature 2 discloses a method of producing silver nanoparticles of nanometer order according to the following steps: a thermally decomposable silver compound and an amine compound are mixed to produce a silver-amine complex as a precursor; 30 to 100 parts by mass of water is added to a reaction system containing the precursor with respect to 100 parts by mass of the silver compound; water is added, and heating is then performed to a decomposition temperature of the silver-amine complex or higher. However, according to studies by the inventors, when 30 parts by mass of water is added with respect to 100 parts by mass of the silver compound, washing for removing water in a post-step is required depending on usage applications and the like, which is complicated. In addition, when silver nanoparticles are repeatedly washed in order to remove water, the amine compound that protects the surface of silver nanoparticles is released, and thus there is a concern of silver particles being fused and silver nanoparticles aggregating.

Therefore, it is desirable that the amount of water that may be included intentionally or inevitably be reduced to about 10 mass % or less, preferably 5 mass % or less, and more preferably 2 mass % or less, for example, 1 mass % or less, with respect to the entire solvent.

The amine compound has one or two or more amino groups, and may have 5 or less carbon atoms. An amine compound having 5 or less carbon atoms has a higher polarity than an amine compound having more than 5 carbon atoms. Therefore, in the second mixing step to be described below, it is possible to minimize the occurrence of coordination competition between a solvent and an amine compound on the surface of the silver compound, and it is possible to appropriately coordinate the amine compound on the surface of the silver compound.

Regarding an amine compound having 5 or less carbon atoms, conventionally known organic solvents can be used without particular limitation. The amine compound includes a monoamine having one amino group and a polyamine having two or more amino groups. Monoamines include ammonia, a primary amine in which one hydrogen atom of ammonia is substituted with a hydrocarbon residue, a secondary amine in which two hydrogen atoms of ammonia are substituted with a hydrocarbon residue, and a tertiary amine in which all of three hydrogen atoms of ammonia are substituted with a hydrocarbon residue. Specific examples of a monoamine having 5 or less carbon atoms include, for example, primary aliphatic amines such as methylamine, ethylamine, n-propylamine, isopropylamine, n-butylamine, pentylamine, 2-methoxyethylamine, 2-ethoxyethylamine, 3-methoxypropylamine, and 3-ethoxypropylamine; secondary aliphatic amines such as dimethylamine, diethylamine, methylbutylamine, ethylpropylamine, and ethyl isopropylamine; and tertiary aliphatic amines such as trimethylamine, dimethylethylamine, and diethylmethylamine.

The amine compound may have 3 or more carbon atoms, for example, 4 or 5 carbon atoms. With this feature, while it has a property of coordinating with a silver compound due to high polarity, a property of protecting the surface of silver nanoparticles is improved, and thus the storage stability of silver nanoparticles can be further improved. The amine compound may be a primary amine. The amine compound may have a boiling point at atmospheric pressure of 150° C. or lower, for example, 70° C. to 150° C. With this feature, in the first and second heating steps to be described below, it is possible to improve the reactivity with a silver compound, and it is possible to set a first temperature T1 of the first heating step and/or a second temperature T2 of the second heating step to be lower, which will be described below.

In the first mixing step, next, the amine compound is added to the solvent to prepare a preliminary mixed liquid. When the preliminary mixed liquid is prepared, as necessary, stirring may be performed. According to the stirring operation, a homogeneous preliminary mixed liquid can be obtained in a relatively short time. Such a stirring operation can be performed using a stirring means, for example, a magnetic stirrer or ultrasonic waves.

In the preliminary mixed liquid, a mixing ratio between the amine compound and the solvent is not particularly limited, and in order to exhibit the effects of the technology disclosed here to a higher degree, the volume ratio between the amine compound and the solvent may be about 1:1 to 1:100, typically 1:2 to 1:50, for example, 1:5 to 1:10.

In the second mixing step, first, a silver compound is prepared. Regarding the silver compound, a thermally decomposable compound is used. Regarding the silver compound, a compound that is decomposed due to heating at, for example, about 90° C. or higher, in an example, 100° C. or higher, and about 200° C. or lower, for example, 150° C. or lower, may be used. Specific examples of a thermally decomposable silver compound include silver salts of organic acids such as silver oxalate, silver formate, silver acetate, silver malonate, silver benzoate, and silver phthalate; silver halides such as silver fluoride, silver chloride, silver bromide, and silver iodide; and silver sulfate, silver nitrate, silver nitrite, and silver carbonate. Among these, silver salts of organic acids or silver carbonate, particularly, silver oxalate is preferably used so that impurities are unlikely to be generated.

In the second mixing step, next, the silver compound is added to the preliminary mixed liquid prepared in the first mixing step to prepare a mixed liquid. As described above, in the present embodiment, an organic solvent having a Log P_{OW} of 2.0 to 4.0 is used. With this feature, in the mixed liquid, an amine compound can be appropriately coordinated around silver ions of the silver compound. In other words, for example, formation of a silver-amine complex compound as described in Patent Literature 2 is minimized so that the amine can be adsorbed on the surface of the silver compound. As a result, in the first heating step to be described below, it is possible to stably generate nuclei. Here, the stirring operation can be appropriately performed in the same manner as in the first mixing step.

In the mixed liquid, a molar ratio of the amine compound to the silver compound (amine compound/silver compound) may be one important parameter for adjusting the homogeneity of silver nanoparticles, specifically, the average particle size and the shape. In the present embodiment, the molar ratio may be a predetermined value or less. When the molar ratio is set to a predetermined value or less, in other words, an amount of the amine compound used with respect to the silver compound is minimized, in the first heating step to be described below, it is possible to slowly generate silver clusters and silver nano colloids serving as nuclei of silver nanoparticles. In addition, it is possible to increase the proportion of silver in the silver nanoparticles and further improve low temperature sinterability. In consideration of this, the molar ratio may be about 1 or less, typically 0.9 or less, preferably 0.8 or less, and more preferably 0.7 or less, for example, 0.5 or less. Regarding the molar ratio, in order to improve the storage stability of silver nanoparticles, the molar ratio of the amine compound to the silver compound may be about 0.1 or more, and preferably 0.2 or more, for example, 0.3 or more.

Here, in a conventional method, when the amount of the amine compound added to the silver compound increases, the particle size is controlled such that it becomes smaller. Actually, in the example in Patent Literature 1, a molar ratio of the amine compound (oleylamine) to the silver compound (silver oxalate) is 2.5 to 8. In addition, in Patent Literature 2, it is recommended that a molar ratio of amino groups to silver ions be 1.6 or more. However, according to studies by the inventors, when the molar ratio increases as described in Patent Literature 1 and 2, a thermal decomposition rate of the silver compound in the heating step increases. Therefore, for example, it is difficult to stably obtain silver nanoparticles having an average particle size of about 50 nm to several hundreds of nm, and nuclei of silver nanoparticles tend to fuse with each other without keeping up with surface protection of the amino group, and coarse particles are likely to be generated. In contrast, in the technology disclosed here, according to a method of heating a predetermined solvent and a predetermined amine compound in two steps, the amount of the amine compound used can be kept lower than before. As a result, more homogeneous silver nanoparticles can be obtained. Therefore, it is possible to appropriately realize a fired film having high density and excellent electrical conductivity and thermal conductivity, and the like.

The mixed liquid may be composed of three components including the solvent, the amine compound, and the silver compound described above, and may contain other optional components as necessary as long as the effects of the technology disclosed here are not significantly reduced. Regarding the optional components, conventionally known components can be used alone or two or more thereof can be used in combination. Regarding an example of the optional component, for example, an additive for adjusting reactivity of silver nanoparticles and improving dispersion stability may be exemplified. Specifically, a reaction catalyst, a reaction adjusting agent, a viscosity adjusting agent, and a dispersant may be exemplified.

(Step 2) First Heating Step

In this step, the mixed liquid obtained in Step 1 is heated to the first temperature T1. The mixed liquid contains a silver compound to which an amine is coordinated. When the mixed liquid is heated to the first temperature T1, silver clusters serving as nuclei (precursor) of silver nanoparticles and silver nano colloids on which silver clusters have grown are partially generated from the surface of the silver compound to which an amine is coordinated. The first temperature T1 is a temperature higher than the temperature in Step 1 and is a temperature lower than the decomposition temperature of the silver compound. The first temperature T1 may vary depending on the composition of the mixed liquid, for example, the type of the solvent, the type and proportion of the amine compound mixed in, and the type and proportion of the silver compound mixed in. In order to further improve homogeneity of silver nanoparticles, the first temperature T1 may be a temperature about 5° C. to 50° C. lower than the decomposition temperature of the silver compound or typically a temperature 10° C. to 40° C. lower, preferably a temperature 15° C. to 30° C. lower. For example, when the decomposition temperature of the silver compound is about 95° C., the first temperature T1 may be about 45° C. to 90° C., typically 55° C. to 85° C., for example, 65° C. to 80° C. Up to the first temperature T1, in order to improve the production efficiency, the temperature may be raised at once or may be gradually raised at a rate of temperature increase ΔT1. The rate of temperature increase ΔT1 may be about 0.1° C./min to 50° C./min, for example, 1° C./min to 30° C./min.

In one preferable aspect, the first temperature T1 is maintained as long as nucleus generation is not saturated. A maintenance time H1 for which the first temperature T1 is maintained is not particularly limited because it may vary depending on, for example, the first temperature T1 and the composition of the above mixed liquid, and the like. The maintenance time H1 may be set so that the saturation concentration of nuclei in the mixed liquid is not exceeded. With this feature, fusion of nuclei in the mixed liquid can be minimized. For example, when isodecanol is used as an organic solvent, n-butylamine is used as an amine compound, and the first temperature T1 is set to 80° C., the maintenance time H1 may be about 20 minutes or shorter, for example, 10 to 15 minutes. In addition, the stirring operation can be appropriately performed in the same manner as in Step 1.

Here, a time at which nuclei reach the saturation concentration can be determined by the following preliminary experiment. That is, first, a plurality of mixed liquids for which only maintenance times H1 are different are prepared. Next, the mixed liquids are centrifuged at a rotational speed of 10,000 rpm for 5 minutes and the supernatant is filtered off with a membrane filter having a pore diameter of 0.1 μm. In this manner, a UV-visible absorption of the solution after particles with a size of 0.1 μm or more are removed is measured. Generally, the concentration of silver nano colloid is proportional to the absorbance. Therefore, it can be confirmed that nuclei have reached the saturation concentration when change in absorbance is no longer observed or has slowed down with respect to the change of the maintenance time H1.

As described above, in this step, the temperature of the mixed liquid is reduced to the first temperature T1 and silver ions contributing to the reaction are limited only to the surface of the silver compound. In addition, in the mixed liquid, the amine is adsorbed on the surface of the silver compound. Therefore, even if the molar ratio of the amine compound to the silver compound is low, a reaction can gradually occur from the surface of the silver compound to stably generate nuclei. Generation of nuclei can be confirmed, for example, according to change in the color of the mixed liquid from yellow to reddish (however, this may vary depending on the first temperature T1 and the maintenance time H1 for which the first temperature T1 is maintained). The average particle size of nuclei of silver nanoparticles is smaller than those of silver nanoparticles obtained in the second heating step to be described below and is, for example, 10 nm or less. Here, this step is typically performed under an air atmosphere. However, this step may be performed under an inert atmosphere.

The amount of nuclei generated in this step can be one important parameter for determining the particle size of silver nanoparticles. The amount of nuclei generated can be adjusted by, for example, the first temperature T1 or the maintenance time H1 for which the first temperature T1 is maintained. In other words, in the technology disclosed here, when a parameter is changed, it is possible to finely adjust the particle size of silver nanoparticles, for example, at a level of 10 to 20 nm. Generally, when the first temperature T1 is set to be higher, the amount of nuclei generated is larger, and silver nanoparticles having a smaller average particle size are easily obtained. According to the technology disclosed here, in an average particle size range of 50 to 200 nm, silver nanoparticles having particularly high homogeneity are easily obtained.

(Step 3) Second Heating Step

In this step, the mixed liquid at the first temperature T1 is heated to the second temperature T2. With this feature, zero-valent silver that is newly generated due to decomposition of the silver compound is fused to nuclei generated in the first heating step. With this feature, nuclei grow homogenously and silver nanoparticles with little deviation from a desired particle size are stably generated in the mixed liquid. This step causes typically generation of a gas (for example, carbon dioxide). The second temperature T2 is a temperature equal to or higher than the decomposition temperature of the silver compound. The second temperature T2 may vary depending on the composition of the mixed liquid, for example, the type of the silver compound, and the type of the solvent. The second temperature T2 may be a temperature lower than a boiling point of at least one solvent. The second temperature T2 is a temperature 5° C. to 40° C. higher than the decomposition temperature of the silver compound, for example, a temperature 10° C. to 30° C. higher. For example, when the decomposition temperature of the silver compound is about 95° C., the second temperature T2 may be about 100° C. to 135° C., for example, 105° C. to 125° C. In order for nuclei to slowly grow, a rate of temperature increase ΔT2 from the first temperature T1 to the second temperature T2 is preferably smaller than the rate of temperature increase ΔT1, and may be about 0.1° C./min to 10° C./min, for example, 2° C./min to 5° C./min for balance with production efficiency.

In one preferable aspect, the second temperature T2 is maintained until the silver compound is completely decomposed. A maintenance time H2 for which the second temperature T2 is maintained is not particularly limited because it may vary depending on, for example, the rate of temperature increase ΔT2, the composition of the above mixed liquid, and the like. The maintenance time H2 may be set to, for example, a time at which generation of a gas due to decomposition of the silver compound is no longer observed. In order to minimize connection between the grown nuclei or improve the production efficiency, the maintenance time H2 may be about 20 minutes or shorter, for example, 10 to 15 minutes. In addition, a total of the maintenance time H1 and the maintenance time H2 may be about 40 minutes or shorter, typically 30 minutes or shorter, for example, 20 to 25 minutes. In addition, the stirring operation can be appropriately performed in the same manner as in Step 1.

Generation of silver nanoparticles can be confirmed according to generation of a gas. Alternatively, the generation can be confirmed according to change in the color of the mixed liquid to darker brown or gray compared to the first heating step (however, this may vary depending on the particle size and shape of the generated silver nanoparticles and the like). Here, this step is performed typically under an air atmosphere. However, this step may be performed under an inert atmosphere. In addition, this step may be performed continuously after the above first heating step, and for example, the mixed liquid may be cooled to room temperature (for example, 25±10° C.) once and then heated to the second temperature T2.

As described above, in the production method of the present embodiment, silver nanoparticles can be generated in the mixed liquid. According to such a production method, silver nanoparticles with little variation from a desired particle size can be obtained with high reproducibility. For example, the standard error of the average particle size between a plurality of production lots can be reduced to about 10 nm or less, typically 5 nm or less, for example, 3 nm or less. Here, the silver nanoparticles generated in the mixed liquid are, for example, naturally cooled, and centrifuged, and the supernatant is removed and a wet silver paste can be then used for preparation. In one preferable aspect, the silver paste can be used for preparation directly without performing a “washing” operation described in Patent Literature 2.

<<Silver Paste>>

The silver paste disclosed here includes silver nanoparticles and an organic solvent. For example, the silver paste can be widely used when it is applied to a substrate to form a film-like component and firing is performed to sinter silver nanoparticles, and a silver fired film is formed on the substrate. In particular, the silver paste can be appropriately used when a fired film is formed on a substrate whose performance deteriorates when exposed to a high temperature (about 200° C. or higher, for example, 150° C. or higher).

The silver nanoparticles of the silver paste disclosed here can be sintered at a low temperature and in a short time, and have excellent storage stability. That is, the silver nanoparticles include silver (Ag) serving as a core and an amine compound attached to the surface thereof. When the amine compound is provided on the surface of silver serving as a core, it is possible to efficiently minimize oxidation and aggregation of silver and it is possible to improve long-term storage properties.

The amine compound attached to the surface of silver serving as a core has 5 or less carbon atoms. With this feature, it is possible to lower the sintering temperature and shorten the sintering time. The amine compound is physically and/or chemically bonded to the surface of silver particles via its own amino group. Specific examples of an amine compound having 5 or less carbon atoms include the amine compounds described above in the section of the production method. The amine compound may be, for example, one or two or more types of alkylamines. The amine compound may have 3 or more carbon atoms, for example, 4 or 5 carbon atoms. With this feature, it is possible to further improve the storage stability.

Regarding the silver nanoparticles, a ratio (M_{NH2}/M_{Ag}) of the number of moles of the amine compound to the number of moles of silver serving as a core is 1 or less. Here, the ratio of M_{NH2}/M_{Ag} is synonymous with the ratio of the number of moles of amino groups (NH₂) to the number of moles of silver ions (AO. When the molar ratio is set to a predetermined value or less, the number of moles of amino groups is minimized, and it is possible to increase the proportion of silver serving as a core. With this feature, it is possible to improve sinterability of silver nanoparticles. As a result, even when the firing temperature is low, for example, at 150° C. or lower, or 100° C. or lower, it is possible to sinter silver nanoparticles in a short time. In addition, it is possible to realize a fired film having a high density while reducing thermal shrinkage to a low level. In consideration of this, the molar ratio is about 0.9 or less, preferably 0.8 or less, more preferably 0.7 or less, and may be, for example, 0.5 or less. In order to improve the storage stability of silver nanoparticles, the molar ratio is about 0.1 or more, preferably 0.2 or more, and may be, for example, 0.3 or more.

The silver nanoparticles preferably have a size (particle size) suitable for sintering at a low temperature. In one preferable aspect, in a number-based particle size distribution based on an FE-SEM observation image, the average particle size is about 300 nm or less, for example, 200 nm or less, as an example, 100 nm or less. When the average particle size is a predetermined value or less, sintering at a low temperature becomes easy and the firing time can be further shortened. In addition, for example, it is possible to stably form a fine line electrode (fine line) with a line width of 1 μm or less, and preferably 500 nm or less. The lower limit of the average particle size is not particularly limited, but is typically larger than that of the silver ultrafine particles described in Patent Literature 1, and may be about 30 nm or more, for example, 50 nm or more. When the average particle size is a predetermined value or more, even if the amount of the amine compound used is reduced, it is possible to maintain a stable state of silver nanoparticles at a high level. In addition, it is possible to improve dispersibility of the silver nanoparticles in the silver paste and it is possible to realize better storage stability.

In another preferable aspect, regarding the silver nanoparticles, in a number-based particle size distribution, a D₁₀ particle size corresponding to a cumulative 10% from the side of a smaller particle size is about 30 nm or more, typically 40 nm or more, for example, 50 nm or more, and about 100 nm or less, for example, 70 nm or less. With this feature, the proportion of ultrafine particles having low surface stability is reduced so that the storage stability of all of the silver nanoparticles can be further improved and low temperature sinterability can be further improved. In addition, in another preferable aspect, regarding the silver nanoparticles, in a number-based particle size distribution, a D₉₀ particle size corresponding to a cumulative 90% from the side of a smaller particle size is about 50 nm or more, typically 70 nm or more, and about 500 nm or less, typically 300 nm or less, for example, 150 nm or less. With this feature, it is possible to further improve low temperature sinterability of silver nanoparticles. In addition, it is possible to form precise fine lines.

In another preferable aspect, regarding the silver nanoparticles, in a number-based particle size distribution, the width W:W=(D₉₀ particle size−D₁₀ particle size)/D₅₀ particle size of the particle size distribution calculated from a D₁₀ particle size corresponding to a cumulative 10% from the side of a smaller particle size, a D₅₀ particle size corresponding to a cumulative 50% from the side of a smaller particle size, and a D₉₀ particle size corresponding to a cumulative 90% from the side of a smaller particle size is about 1.2 or less, and preferably 1 or less. When the width W of the particle size distribution is a predetermined value or less, this indicates that silver nanoparticles have a certain degree of homogeneity. With this feature, it is possible to stably realize a fired film having high smoothness and homogeneity and having excellent electrical conductivity and thermal conductivity. The lower limit value of the width W of the particle size distribution is not particularly limited, and is typically 0.4 or more, and preferably 0.5 or more. When the width W of the particle size distribution is a predetermined value or more, this indicates that the particle size distribution of silver nanoparticles is broad and the particle size has a predetermined width. With this feature, it is possible to stably realize a fired film having a high density and improved filling properties.

In another preferable aspect, regarding the silver nanoparticles, in a number-based particle size distribution, a ratio (standard deviation 6/average particle size) of the standard deviation σ to the average particle size, that is, a coefficient of variation (CV), is about 0.5 or less, and preferably 0.3 or less, for example, 0.25 or less. With this feature, it is possible to stably realize a fired film having high smoothness and homogeneity and having excellent electrical conductivity and thermal conductivity.

The shape of fine particles constituting silver nanoparticles is typically a substantially spherical shape, and for example, has an average aspect ratio (ratio of major axis/minor axis) of about 1 to 2, for example, 1 to 1.5. According to such a shape, it is possible to appropriately form a fired film having excellent smoothness and homogeneity. Here, in this specification, the term “spherical shape” indicates a shape that can be generally regarded as a sphere (ball) as a whole, and can include an elliptical shape, a polygonal shape, a disc-shaped sphere, and the like.

Even if the silver nanoparticles disclosed here that are dispersed in an organic solvent are left under an environment of 25° C. for 10 months, aggregates with a size of 1 μm or more are not observed. In other words, the silver nanoparticles disclosed here have excellent storage stability even though the number of carbon atoms of the amine compound attached to the surface is small at 5 or less and the molar amount of the amine compound with respect to silver serving as a core is minimized. Here, a determination of whether there are aggregates can be performed by measurement using a grind gauge. A detailed measurement method will be described in test examples to be described below.

The organic solvent for the silver paste disclosed here is not particularly limited, and one or two or more of various organic solvents known to be usable for this type of application can be appropriately used depending on applications and the like. The organic solvent may include an organic solvent having a Log P_{OW} of 2.0 to 4.0 due to a step of producing silver nanoparticles. In order to improve storage stability of the silver paste and workability when the silver paste is used, the organic solvent may be mainly composed of a high-boiling point organic solvent (a component occupying 50 volume % or more) having a boiling point of about 200° C. or higher, for example, 200° C. to 300° C. Specific examples of a high-boiling point organic solvent include, for example, alcohol solvents such as terpineol, texanol, dihydroterpineol, and benzyl alcohol; glycol solvents such as ethylene glycol and diethylene glycol; glycol ether solvents such as diethylene glycol monoethyl ether, diethylene glycol monobutyl ether, and propylene glycol monophenyl ether; ester solvents such as isobornyl acetate, ethyl diglycol acetate, butyl glycol acetate, butyl diglycol acetate, butyl cellosolve acetate, and butyl carbitol acetate; hydrocarbon solvents such as toluene and xylene; and mineral spirits.

The content of the silver nanoparticles in the silver paste is not particularly limited, but it may be about 30 mass % or more, typically 50 to 95 mass %, for example, 80 to 90 mass % when the entire silver paste is set as 100 mass %. In addition, the content of the organic solvent in the silver paste is not particularly limited, but it may be about 70 mass % or less, typically 5 to 50 mass %, for example, 10 to 20 mass % when the entire silver paste is set as 100 mass %. When the content is within the above range, it is possible to further improve the storage stability of the silver paste and improve the workability during film formation. In addition, it is possible to appropriately realize a fired film having a high density and excellent electrical conductivity and thermal conductivity, and the like. In addition, it is possible to appropriately form a thick fired film with a thickness of, for example, 100 μm or more while reducing thermal shrinkage to a low level.

The silver paste may be composed of silver nanoparticles and an organic solvent, and may contain various additives as necessary in addition to the silver nanoparticles and the organic solvent. Regarding the additives, those that are known to be usable for a general silver paste can be appropriately used as long as the effects of the technology disclosed here are not significantly reduced. Examples of additives include a binder, a dispersant, a surfactant, an emulsifier, a leveling agent, an anti-foaming agent, a thickener, a plasticizer, a pH adjusting agent, a stabilizer, an antioxidant, a preservative, a coloring agent (a pigment, a dye, etc.), a sintering aid, and an inorganic filler. Examples of a binder include a (meth)acrylic resin, a polyester resin, an epoxy resin, a phenolic resin, a silicone resin, and a urethane resin.

While examples according to the present invention will be described below, the present invention is not intended to be limited to those described in the following examples.

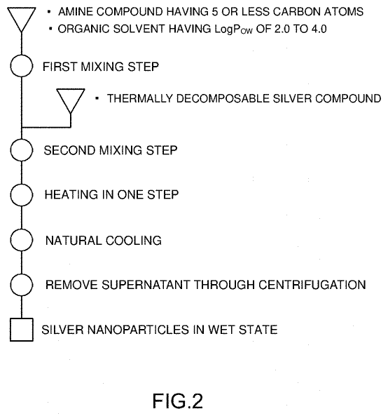

### Test Example I

[Example 1] In Example 1, silver nanoparticles were prepared according to the flowchart in FIG. 1. That is, first, in a flask, under an environment of 25° C., 1.65 mL of n-butylamine (the number of carbon atoms: 4) as an amine compound was weighed out and mixed with 10 mL of isodecanol (Log P_{OW}: 3.94) as an organic solvent to prepare a preliminary mixed liquid (first mixing step). 5.06 g of silver oxalate as a silver compound was added thereto and the mixture was stirred using a magnetic stirrer to prepare a mixed liquid (second mixing step). Next, the flask containing the mixed liquid was immersed in an oil bath of which the temperature was adjusted to a first temperature T1 of 80° C. in advance and heated for 10 minutes while stirring (first heating step). With this feature, the mixed liquid became reddish. Next, the reddish mixed liquid was heated to a second temperature T2 of 108° C. In this case, the rate of temperature increase ΔT2 was 4° C./min to 5° C./min. Then, the mixed liquid was heated for 20 minutes while stirring (second heating step). Then, when the temperature of the mixed liquid reached 95° C., silver oxalate was decomposed to generate a gas. Then, the mixed liquid was gradually changed to a brown suspension. After 20 minutes, the flask was removed from the oil bath, and cooled, and the supernatant was then removed through centrifugation to prepare wet silver nanoparticles. In Example 1, these procedures were performed 6 times in total and 6 lots of silver nanoparticles (Example 1) were obtained.

[Comparative Example 1] In Comparative Example 1, silver nanoparticles were prepared according to the flowchart in FIG. 2. That is, silver nanoparticles were prepared in the same manner as in Example 1 except that a flask containing a mixed liquid was immersed in an oil bath of which the temperature was adjusted to 100° C. in advance and heated for 30 minutes while stirring (that is, heating was performed in one step, and no stepwise heating was performed) in addition to the first heating step and the second heating step. In Comparative Example 1, these procedures were performed 17 times in total and 17 lots of silver nanoparticles (Comparative Example 1) were obtained.

[Evaluation items] Regarding the obtained silver nanoparticles, the following items were evaluated.

### (A) FE-SEM Observation

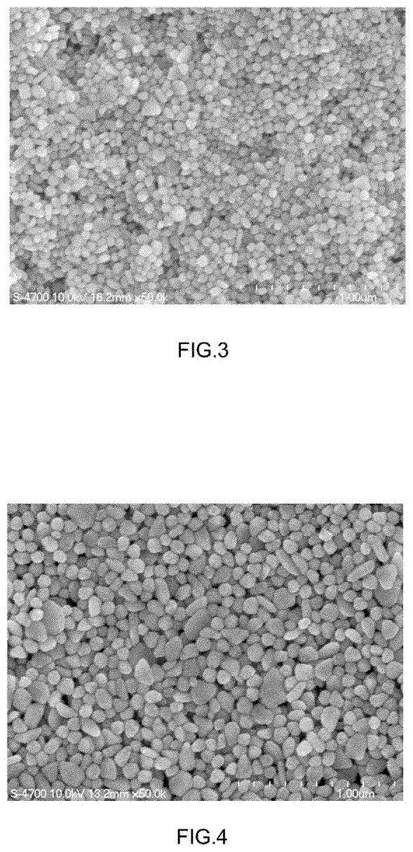

The shape of silver nanoparticles was observed using an FE-SEM (S-4700 commercially available from Hitachi High-Technologies Corporation). FIG. 3 shows an example of an observation image of the silver nanoparticles according to Example 1 and FIG. 4 shows an example of an observation image of the silver nanoparticles according to Comparative Example 1.

### (B) Particle Size Distribution

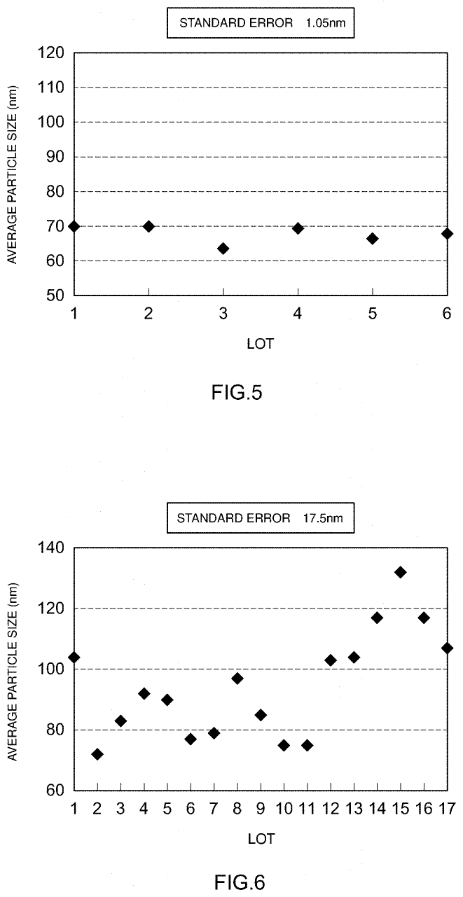

Based on the FE-SEM observation image, the particle size distribution of silver nanoparticles was measured. The particle size was determined by arbitrarily extracting a total of 200 to 300 non-overlapping silver nanoparticles from a total of three images captured at a magnification of 10 k in searching for a part with few overlapping particles and measuring a Feret diameter. Then, the number-based arithmetic average value was calculated as an average particle size. In addition, the standard error of the average particle size was calculated. FIG. 5 shows the result according to Example 1 and FIG. 6 shows the result according to Comparative Example 1.

[Evaluation results] As shown in FIGS. 3 and 4, compared to the silver nanoparticles (FIG. 4) of Comparative Example 1, the silver nanoparticles (FIG. 3) of Example 1 had less variation in shape and size. In addition, as shown in FIGS. 5 and 6, in the silver nanoparticles (FIG. 6) of Comparative Example 1, the average particle size was distributed in a range of 70 to 140 nm and the standard error of the average particle size was 17.5 nm. That is, the variation in the average particle size between lots was large. On the other hand, in the silver nanoparticles (FIG. 5) of Example 1, the average particle size was controlled such that it was in a range of 60 to 70 nm and the standard error of the average particle size was significantly reduced to 1.05 nm. That is, the variation in the average particle size between lots was small. Based on the above results, it was found that, when nucleus generation and nucleus growth were caused stepwise according to two-step heating, it was possible to reduce the variation between lots and it was possible to obtain silver nanoparticles having a desired particle size with favorable reproducibility.

### Test Example II: Examination of Solvent During Preparation of Silver Nanoparticles

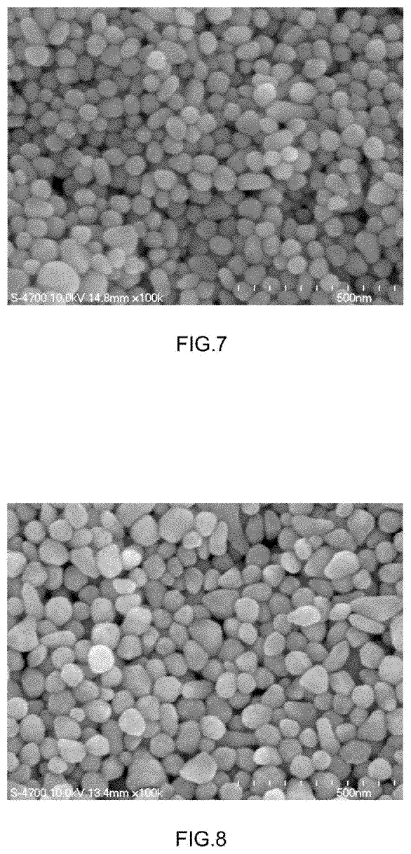

In this test example, the type of the organic solvent was examined. That is, in Examples 2 to 4 and Comparative Examples 2 and 3, silver nanoparticles were prepared in the same manner as in Example 1 except that an organic solvent having a Log P_{OW} shown in the following Table 1 was used. Then, the obtained silver nanoparticles were evaluated in the same manner as in Example 1. The results are shown in Table 1. Table 1 shows the particle shape and the average particle size, a number-based D₁₀ particle size, D₅₀ particle size, and D₉₀ particle size calculated from the particle size distribution, the width W:W=(D₉₀ particle size−D₁₀ particle size)/D₅₀ particle size of the particle size distribution, and the coefficient of variation CV. In addition, FIGS. 7 to 10 show FE-SEM observation images of the silver nanoparticles according to Examples 2 to 4, and Comparative Example 3.

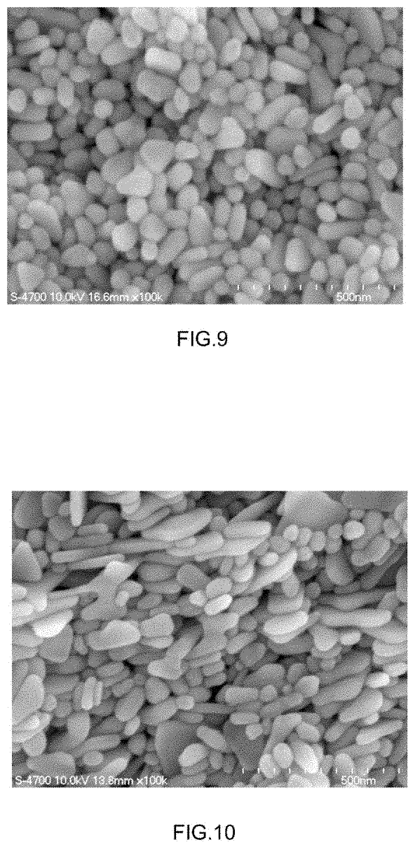

TABLE 1

| | | | M_{NH2}/ | FE-SEM observation | | | | | | | |
|---|---|---|---|---|---|---|---|---|---|---|---|
| | | | M_{Ag} | | | Average | | | | (D90 − | |
| | Organic | | (molar | | Particle | particle size | D10 | D50 | D90 | D10)/ | |
| | solvent | LogPow | ratio) | Image | shape | (mn) | (mil) | (mil) | (nm) | D50 | CV |
| Comparative | Octanol | >4.5 | 0.5 | (unreacted) | | | | | | | |
| Example 2 | | | | | | | | | | | |
| Example 2 | Isodecanol | 3.94 | 0.5 | FIG. 7 | Substantially | 62 | 49 | 61 | 76 | 0.44 | 0.16 |
| | | | | | spherical | | | | | | |
| Example 3 | Texanol | 3.47 | 0.5 | FIG. 8 | Substantially | 76 | 58 | 75 | 93 | 0.47 | 0.2 |
| | | | | | spherical | | | | | | |
| Example 4 | Hexanol | 2.03 | 0.5 | FIG. 9 | Substantially | 70 | 52 | 65 | 97 | 0.69 | 0.25 |
| | | | | | spherical | | | | | | |
| Comparative | Butanol | 0.88 | 0.5 | FIG. 10 | Many | — | — | — | — | — | — |
| Example 3 | | | | | variants | | | | | | |

As shown in Table 1, in Comparative Example 2, no generation of silver nanoparticles was confirmed. The reason for this was speculated to be as follows. Since the Log P_{OW} of the solvent was too large, in other words, the hydrophobicity of the solvent was too high, nucleus generation and/or nucleus growth was inhibited and no silver-amine complex was formed. On the other hand, as shown in Table 1 and FIG. 10, in Comparative Example 3, the variation in the appearance (shape and size) of silver nanoparticles was relatively large. The reason for this was speculated to be as follows. Since the Log P_{OW} of the solvent was too small, in other words, the hydrophilicity of the solvent was too strong, the reaction rate was too high in the first and second firing steps. In contrast to these comparative examples, as shown in Table 1 and FIGS. 7 to 9, in Examples 2 to 4, the average particle size was 60 to 75 nm, the D₁₀ particle size was 45 to 60 nm, the D₉₀ particle size was 75 to 100 nm, the width W of the particle size distribution was 0.4 to 0.7, and the CV was 0.15 to 0.25, and the variation in shape and size was smaller than that of Comparative Example 3.

### Test Example III: Examination of Conductivity and Dispersion Stability

In this test example, silver nanoparticles of Comparative Example 4 were newly prepared according to Test No. 2 of Patent Literature 2, and the stability was evaluated together with the silver nanoparticles of Example 1. That is, in Comparative Example 4, silver nanoparticles were prepared in the same manner as in Comparative Example 1 except that the number of moles of n-butylamine was 6.0 times the number of moles of silver oxalate, 80 parts by mass of water with respect to 100 parts by mass of silver oxalate was used as a solvent, heating was performed at a rate of temperature increase of 5° C./min to a heating temperature of 110° C., and heating continued until gas generation was stopped. Next, according to paragraph 0034 in Patent Literature 2, an operation of performing washing by adding methanol to a mixed liquid after silver nanoparticles were generated and removing the supernatant through centrifugation was performed twice. Then, for the silver nanoparticles of Example 1 and Comparative Example 4, an operation of substituting the solvent with propylene glycol monophenyl ether (PhFG) and removing the supernatant through centrifugation was performed twice. With this feature, silver nanoparticles wet with PhFG were obtained.

[Preparation of silver paste] Silver pastes having a composition shown in the following Table 2 were prepared using the silver nanoparticles of Example 1 and Comparative Example 4. Specifically, the following materials were weighed out, and mixed with a spatula, and kneading was then performed at a rotational speed of 1,200 rpm for 2 minutes twice in total using a rotation revolution mixer Awatori-rentaro (registered trademark, commercially available from Thinky Corporation).

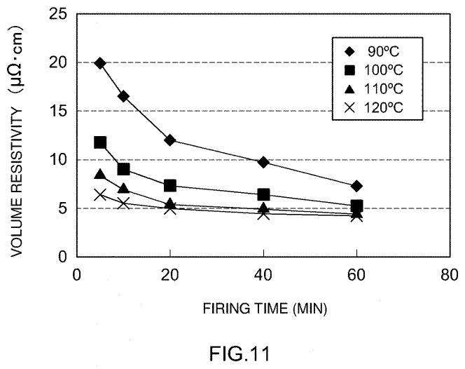

TABLE 2

| Material | Content (wt %) |
|---|---|
| Wet silver nanoparticles | 84 |
| Vehicle containing polyester resin and urethane resin | 11 |
| Organic solvent (PhFG) | 5 |

[Evaluation of conductivity] Low temperature sinterability of the silver paste of Example 1 was evaluated by changing firing conditions. Specifically, first, according to a method of screen printing (#400), the silver paste of Example 1 was applied to a commercially available PET film (Lumirror (trademark) S10 commercially available from Toray Industries, Inc.) to form a 15 mm×30 mm rectangular pattern (with a film thickness of 2.7 to 3.0 μm). This was put into an air drying oven and dried at 60° C. for 10 minutes. Next, firing was performed at a low temperature of 90° C. to 120° C. for 5 to 60 minutes in the atmosphere, and fired films were formed by changing only firing conditions. Next, in the fired films, a sheet resistance value (μΩ) and a film thickness (cm) were measured. Here, the sheet resistance value was measured using a resistivity meter (Loresta GP MCP-T610, commercially available from Mitsubishi Chemical Analytech Co., Ltd.). In addition, the film thickness was measured using a surface roughness measuring machine (Surfcom 480A, commercially available from Tokyo Seimitsu Co., Ltd.). Then, the volume resistivity was calculated from the product of the sheet resistance value and the film thickness. The results are shown in FIG. 11.

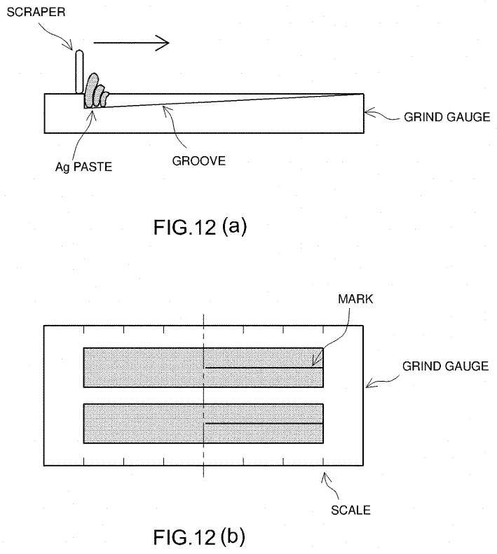

FIG. 11 is a graph showing the relationship between the firing conditions (a firing temperature and a firing time) and the volume resistivity of the silver paste of Example 1. As shown in FIG. 11, for example, the silver paste of Example 1 was fired at 90° C. for 30 minutes or fired at 100° C. for 10 minutes, and it was possible to realize a fired film with a volume resistivity of 10 μm·cm or less. In addition, according to firing at 120° C. for 30 minutes, it was possible to realize a fired film with a volume resistivity of 5 μm·cm or less. In this manner, according to the silver paste of Example 1, it was possible to realize a fired film having excellent conductivity according to firing at a low temperature and/or in a short time.

[Evaluation of the presence of aggregates] Aggregates in the silver pastes of Example 1 and Comparative Example 4 were evaluated using a grind gauge (GW-2392, commercially available from Taiyu Kizai K.K.). FIG. 12 shows schematic explanatory diagrams for explaining a method of evaluating aggregates using a grind gauge, FIG. 12(a) shows a cross-sectional view, and FIG. 12(b) shows a plan view. Specifically, as shown in FIG. 12(a), the silver paste (Ag paste) was poured into a groove provided on the grind gauge and spread in a film form when a scraper was moved in the arrow direction. The groove of the grind gauge was inclined and the groove gradually became shallower. Therefore, when there were particles having a particle size larger than the depth of the groove, linear marks remained on the formed film. Therefore, when the mark on the formed film was checked against the scale on the grind gauge, it was possible to check whether there were aggregates and their sizes. Here, in the grind gauge, it was possible to check whether there were aggregates with a size of 1 μm or more.

As a result, immediately after preparation, the silver paste of Comparative Example 4 already contained aggregates with a size of 100 μm. The reason for this was speculated to be as follows. The amine compound on the surface of silver nanoparticles was released by repeating washing and centrifugation, silver particles were fused together, and the silver nanoparticles were aggregated. On the other hand, in the silver paste of Example 1, immediately after preparation, aggregates with a size of 1 μm or more were not observed. That is, the silver paste of Example 1 had better dispersion stability than the silver paste of Comparative Example 4.

Thus, as an additional test, the silver paste of Example 1 was stored under an environment of 25° C. for 10 months and it was then checked again whether there were aggregates. As a result, no aggregates with a size of 1 μm or more were observed even after the silver paste of Example 1 was stored for 10 months. In addition, no change in appearance such as separation of the silver paste was observed. That is, the silver paste of Example 1 also had excellent long-term storage stability. Based on the above results, it was found that the silver paste disclosed here had low temperature sinterability and long-term storage properties.

Here, although not particularly limited, the inventors believe the reason for the silver paste of Example 1 having better dispersion stability than the silver paste of Comparative Example 4 to be as follows. That is, in wet silver nanoparticles, amine molecules were in an adsorption (coordination) equilibrium state between an adsorption state with respect to the surface of silver nanoparticles and desorption in the solvent. Here, when the solvent was a high-polarity solvent such as an alcohol with short alkyl chains, ketone, an amide, and an ester, solvent molecules with a high polarity were likely to be adsorbed on the surface of silver nanoparticles. With this feature, coordination competition between solvent molecules and amine molecules occurred on the surface of silver nanoparticles, and adsorption equilibrium of amine molecules was easily biased toward the desorption side. In addition, when an amine compound had 5 or less carbon atoms, it had a higher polarity than when it had more carbon atoms. Therefore, the affinity between amine molecules and the high-polarity solvent increased and amine molecules were easily released from the surface of silver nanoparticles. As a result, as in Comparative Example 4, it was thought that, when silver nanoparticles were prepared in a high-polarity solvent and substitution with a paste solvent (organic solvent) was performed in a washing step, amine molecules that were easily released in the high-polarity solvent were removed in the washing step, and the dispersion stability of silver nanoparticles was reduced.

On the other hand, as in Example 1, when silver nanoparticles were prepared in a low-polarity solvent having a Log P_{OW} of 2.0 to 4.0, solvent molecules were less likely to be adsorbed on the surface of silver nanoparticles. With this feature, it was possible to minimize the occurrence of coordination competition between solvent molecules and amine molecules on the surface of silver nanoparticles. In addition, when the low-polarity solvent was used, it was possible to reduce the affinity between solvent molecules and amine molecules. When these effects were combined, the adsorption equilibrium of amine molecules was easily biased toward the adsorption side, and it was possible to stably maintain a state in which amine molecules were adsorbed on the surface of silver nanoparticles. As a result, it was thought that, even if substitution with a paste solvent was performed in a washing step, it was possible to realize excellent dispersion stability without excessively removing amine molecules from the surface of silver nanoparticles.

### Test Example IV: Examination of Organic Solvent and Binder Type of Silver Paste

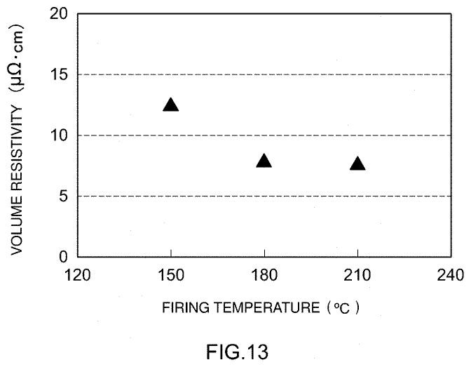

In this test example, a silver paste having a composition shown in the following Table 3 was prepared in the same manner as in Example 1 using the silver nanoparticles of Example 3, that is, wet silver nanoparticles prepared using texanol as an organic solvent. Then, after a rectangular pattern was formed in the same manner as in Example 1, firing was performed at 150° C. to 210° C. for 10 minutes in the atmosphere to form a fired film. Next, the sheet resistance value and the film thickness were measured, and the volume resistivity was calculated. The results are shown in FIG. 13.

TABLE 3

| Material | Content (wt %) |
|---|---|
| Wet silver nanoparticles in texanol (prepared | 72 |
| in texanol, unwashed) | |
| Vehicle containing acrylic resin | 14 |
| Organic solvent (texanol) | 14 |

FIG. 13 is a graph showing the relationship between the firing temperature and the volume resistivity of the silver paste of Example 3. As shown in FIG. 13, the silver paste of Example 3 was fired, for example, at 150° C. for 10 minutes, and thus it was possible to realize a fired film with a volume resistivity of 15 μm·cm or less. In addition, firing was performed at 180° C. for 10 minutes, and it was possible to realize a fired film with a volume resistivity of 10 μm·cm or less. Thus, according to the technology disclosed here, even if the type of the organic solvent or the binder was changed, it was possible to realize excellent conductivity according to firing at a low temperature and/or in a short time.

While the present invention has been described above in detail, these are only examples, and the present invention can be variously modified without departing from the spirit and scope of the present invention. The technology described in the claims includes various modifications and alternations of the above exampled embodiments. For example, a part of the above embodiment can be replaced with another modification or another embodiment can be added to the above embodiment. In addition, if technical features are not described as essential, they can be appropriately deleted.

1-8. (canceled)

9. A method of producing silver nanoparticles, comprising:
a mixing step of mixing a thermally decomposable silver compound, an amine compound having 5 or less carbon atoms, and a solvent including an organic solvent having an octanol/water partition coefficient Log P_{OW} of 2.0 to 4.0 at a temperature at which the silver compound and the amine compound do not chemically react;
a first heating step of heating a mixed liquid obtained in the mixing step to a first temperature lower than a decomposition temperature of the silver compound to generate nuclei of the silver nanoparticles in the mixed liquid; and
a second heating step of heating the mixed liquid containing nuclei of the silver nanoparticles to a second temperature equal to or higher than a decomposition temperature of the silver compound to generate the silver nanoparticles in the mixed liquid.

10. The production method according to claim 9, wherein,
in the first heating step, the first temperature is set to a temperature 15° C. to 30° C. lower than a decomposition temperature of the silver compound.

11. The production method according to claim 9, wherein,
in the first heating step, the heating time is set to 20 minutes or shorter.

12. The production method according to claim 9, wherein,
in the second heating step, the heating time is set to 20 minutes or shorter.

13. The production method according to claim 9, wherein,
in the mixing step, a ratio of the number of moles of the amine compound to the number of moles of the silver compound is 1 or less.

14. The production method according to claim 9, wherein,
in the mixing step, the solvent includes water.

15. The production method according to claim 14, wherein,
the amount of the water is 2 mass % or less with respect to all of the solvent.

16. The production method according to claim 14, wherein,
the amount of the water is 1 mass % or less with respect to all of the solvent.

17. A method of forming a conductive layer comprising:
applying to a substrate a silver paste including an organic solvent and the silver nanoparticles produced by the production method according to claim 10.

18. A silver paste including silver nanoparticles and an organic solvent, wherein
the silver nanoparticles include silver serving as a core and an amine compound having 5 or less carbon atoms attached to the surface thereof;
a ratio (M_{NH2}/M_{Ag}) of the number of moles of the amine compound to the number of moles of silver serving as the core is 1 or less; and
even if the particles are left under an environment of 25° C. for 10 months, aggregates with a size of 1 μm or more are not observed in measurement using a grind gauge.

19. The silver paste according to claim 18, wherein
the silver nanoparticles have an average particle size of 50 to 200 nm in a number-based particle size distribution based on an observation image under a field emission scanning electron microscope.

20. The silver paste according to claim 18, wherein,
in the silver nanoparticles, in a number-based particle size distribution based on an observation image under a field emission scanning electron microscope, a width W:W=(D₉₀ particle size−D₁₀ particle size)/D₅₀ particle size of a particle size distribution calculated from a D₁₀ particle size corresponding to a cumulative 10% from the side of a smaller particle size, a D₅₀ particle size corresponding to a cumulative 50% from the side of a smaller particle size, and a D₉₀ particle size corresponding to a cumulative 90% from the side of a smaller particle size is 0.5 or more and 1 or less.
